(19) United States
(12) Patent Application Publication
(10) Pub. No.: US 2003/0169590 A1
(43) Pub. Date: Sep. 11, 2003

(54) Container

(76) Inventors: Ole Sorli, Oslo (NO); Jeremy H. Burroughes, Cambridge (GB); Stephen K. Heeks, Cambridge (GB)

Correspondence Address: HARNESS, DICKEY & PIERCE, P.L.C., P.O. BOX 828, BLOOMFIELD HILLS, MI, 48303, US

(21) Appl. No.: 10/346,882

(22) Filed: Jan. 17, 2003

Related U.S. Application Data
(60) Provisional application No. 60/349,571, filed on Jan. 18, 2002.

(30) Foreign Application Priority Data
Nov. 8, 2001 (GB) 0126847.3
Apr. 18, 2002 (GB) 0208866.4

(51) Int. Cl. F21V 33/00

(52) U.S. Cl. 362/154

(57) ABSTRACT

A container for storage wherein an organic light emitting device is provided on a surface thereof or as part of a wall thereof such that light emitted from the organic light emitting device is visible from the exterior of the container.

### CROSS-REFERENCE TO RELATED APPLICATIONS

This application claims the benefit of U.S. Provisional Application No. 60/349,571 filed on Jan. 18, 2002. The disclosure(s) of the above application(s) is (are) incorporated herein by reference.

### FIELD OF THE INVENTION

The present application relates to lighting applications for containers.

### BACKGROUND OF THE INVENTION

It is desirable for containers for storage to combine robust protection for the goods being stored with highly visible identification. One approach to increasing the visibility of containers is the use of luminescent means on said packaging. Various luminescent means have been used with packaging for a number of years now. One known luminescent means used in containers are inorganic electroluminescent devices as disclosed in, for example, U.S. Pat. No. 6,213,616 and U.S. Pat. No. 5,676,451 however inorganic electroluminescent devices require high operating voltage which in itself is undesirable due to the resultant expense and high power consumption and which also leads to the additional disadvantage of a bulky power source. Similar disclosure is made in WO 00/07190 with respect to containers for audio CDs. Another luminescent means used in containers are light emitting diodes (LEDs) as disclosed in, for example, DE 29912722 U1 and U.S. Pat. No. 6,229,779 wherein LEDs are used with packaging for a CD, however LEDs provide a point source of light and as such are limited in terms of the information they can display unless used in conjunction with a construction that is both complex and unwieldy. Finally, packaging for sound and/or video storage media wherein the packaging comprises a fluorescent dye is disclosed in EP 0409483. Although these prior art luminescent means for containers do increase the visibility of the containers, there remains a need for a container for storage comprising a luminescent means that is thin, lightweight, has low power consumption and is capable of providing a versatile, high information content displays.

### OBJECT OF THE INVENTION

It is an object of the invention to provide means for displaying information on a container for storage that is highly visible, versatile and practical.

### SUMMARY OF THE INVENTION

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

In a first aspect, the invention provides container for storage wherein an organic light emitting device is provided on a surface thereof or as part of a wall thereof such that light emitted from the organic light emitting device is visible from the exterior of the container.

Preferably, the container for storage is provided with a plurality of independently operable organic light emitting devices.

Preferably, the organic light emitting device is a polymeric light emitting device.

Preferably, the organic light emitting device comprises a semi-transparent electrode for transmission of light emitted from an electroluminescent material and a reflective material for reflection of ambient light provided on the side of the electroluminescent material distant from said semi-transparent electrode. Preferably, the semi-transparent electrode is an anode and the reflective material comprises a cathode layer.

Preferably, the container for storage comprises at least one means for operating the organic light emitting device. More preferably, the means for operating comprises a photodetector that activates the organic light emitting device upon exposure to ambient light. Preferably, the means for operating further comprises a manually operable switch that is capable of overriding the operation of the photodetector.

Preferably, the container for storage is removably attached to a surface of the container for storage. More preferably, the container for storage is provided with means for retaining the organic light emitting device.

Preferably, the organic light emitting device comprises a substrate in contact with one electrode and an encapsulant in contact with the other electrode wherein the substrate or encapsulant is provided by a wall of the electroluminescent device.

Preferably, the container is a container for storage of audio and/or video storage media.

Preferably, the container for storage further comprises a power source that provides a voltage of less than 20V, more preferably 2-5V, for operation of the organic light emitting device.

Preferably, the organic light emitting device is provided on an inner surface of a transparent wall of the container for storage.

In a second aspect, the invention provides a container for storage and at least one organic electroluminescent device attachable to at least one surface of said container for storage such that light emitted from the organic light emitting device is visible from the exterior of the container when the kit is assembled.

Preferably, the organic electroluminescent device is removably attachable to the at least one surface of said container for storage.

In a third aspect, the invention provides a method of forming a container for storage as defined in claim 1 comprising the step of attaching at least one organic light emitting device to at least one surface of a container for storage.

Preferably, the organic light emitting device is attached to the container for storage by lamination.

Preferably, the organic light emitting device is attached to the container for storage by means of an adhesive.

In a fourth aspect, the invention provides a plurality of units, each unit having:

a first side and an opposing second side,

a light source on said first side such that light emitted from the light source is visible from the exterior of the unit, and

a detection means on said first side

wherein said plurality of units is arranged in a stack such that the first side of at least one of the endmost units of the stack faces outward, and wherein the light source provided on said at least one endmost unit is activatable in response to a signal from the detection means provided on said at least one endmost unit, all other light sources within the stack being deactivated.

Preferably, the detection means comprises a means for detecting light.

Preferably, the first or second surface of the second unit is in contact with the first surface of the first unit and overlays at least part of the means for detecting light.

Preferably, the first surface or second surface of the second unit overlays the entire area of the means for detecting light.

Preferably, the light source is an organic light emitting device.

Preferably, the light source is activated upon detection of ambient light by the means for detecting light.

The term “surface” as used herein refers to an outer surface of the container for storage or an inner surface of a side of the container for storage wherein said side of the container is semi-transparent.

The term “organic light emitting device” as used herein refers to a device comprising at least one organic semiconductive material located between an anode and a cathode wherein charge carriers are injected into said organic semiconductive material upon application of an electric field between the anode and the cathode and light is emitted from said organic semiconductive material.

The term “stack” as used herein includes a stack arranged horizontally or vertically relative to a stacking surface. The individual units within the stack may be in direct contact with one another or may be held separately from one another by any suitable holding means.

In the simplest construction, an OLED comprises a substrate onto which is deposited an anode comprising a sheet of material suitable for injecting holes (commonly indium tin oxide), a cathode comprising a sheet of material of lower workfunction than the anode material that is capable of injecting electrons and a film of electroluminescent material between these sheets wherein holes and electrons combine to form an exciton which undergoes radiative decay to give light. The information displayed by such a device may be varied, for example to provide a flashing image by use of suitable drive circuitry. A plurality of such devices may be combined to provide a segmented display as disclosed in, for example, WO 00/44203. In the more complex passive or active matrix display architectures, it is possible to produce moving images from a single construction. For example, such an OLED may be used to display images from a video signal transmitted to the OLED by suitable transmission means.

The semi-transparent substrate typically comprises glass and/or plastic. Substrates comprising a plastic may be flexible, thus giving a flexible OLED.

OLEDs may advantageously be encapsulated to minimise degradation from exposure to the atmosphere. Encapsulation may be accomplished by means of an airtight casing as disclosed in, for example, U.S. Pat. No. 5,882,761. Alternatively, OLEDs comprising a flexible substrate are advantageously encapsulated by a flexible, airtight barrier layer or stack of layers in order to retain their flexible properties as disclosed in, for example, WO 01/05205.

The emissive material may be a small molecule such as an aluminum quinolinol complex as disclosed in, for example, U.S. Pat. No. 4,539,507 or polymers as disclosed in, for example, WO 90/13148. For small molecule devices, the diode preferably further comprises a hole transport layer between the anode and the light emissive material and an electron transport layer between the cathode and the light emissive layer. For polymeric devices, the diode preferably further comprises a hole injection layer located between the anode and the emissive layer. Materials suitable for use as the hole injection layer include, poly(ethylene dioxy thiophene)/polystyrene sulfonate (PEDOT/PSS) as disclosed in WO 98/05187 or polyaniline as disclosed in WO 92/22911 and U.S. Pat. No. 5,470,505.

For polymeric devices, the film of light emissive material may comprise hole and/or electron transport materials in addition to the electroluminescent material. Devices of this type, and suitable materials for hole and/or electron injection are disclosed in, for example, WO 99/48160, WO 00/55927 and WO 99/54385.

The display may be monochrome or multicolour, especially full colour. Full colour displays are advantageously prepared by inkjet deposition of the electroluminescent material as disclosed in, for example, EP 0880303. Inkjet printing may also be applied to any monochrome display.

The container for storage may be, for example, plastic boxes for audio and/or video storage media (whether bearing recorded information or not) or software. Examples of such boxes include boxes for compact discs (CDs), digital versatile discs (DVDs), minidiscs, floppy discs, audio and video cassettes, etc. Alternatively, the container for storage may contain any other type of goods, for example food, hardware or other consumer, household or capital goods.

The OLED and container for storage may be manufactured separately and then combined. Suitable processes for combining the OLED and container include adhesion with a suitable adhesive, lamination at elevated pressure and/or temperature or insertion of the OLED into means for retaining an OLED built into the structure of the container for storage. Alternatively, a surface of the container for storage may form the substrate or encapsulant for the OLED.

The unique properties of OLEDs render them particularly advantageous to the application of the present invention. In particular, OLEDs only require low drive voltage, are thin, patternable, efficient and emissive. Further advantages include their applicability as high information content displays and the option of flexibility in which case they may be contoured to fit containers not having a flat surface.

Alternative means for displaying information on a container for storage can be envisaged however none of these alternatives possess the full range of advantages afforded by OLEDs. For example:

LEDs, as disclosed to in the aforementioned prior art, provide point sources of light and as such are very limited in the information they can display.

Reflective LCDs are not emissive which detracts from their visibility, particularly at low levels of ambient light.

Inorganic electroluminescent devices are typically driven at ca. 50-100 V whereas OLEDs are typically driven at around 2-5V. Inorganic electroluminescent devices are also limited in terms of the colours they are capable of displaying.

### BRIEF DESCRIPTION OF THE DRAWINGS

The present invention will become more fully understood from the detailed description and the accompanying drawings, wherein:

The invention will now be described in further detail, by way of example only, with reference to the accompanying drawings in which:

FIG. 1 shows a first CD box according to the invention. FIG. 2 shows a cross-section of a first CD box according to the invention through OLED 11a.

FIG. 3 shows a second CD box according to the invention.

FIG. 4 shows a stack of CD boxes according to the invention.

### DETAILED DESCRIPTION OF THE PREFERRED EMBODIMENTS

The following description of the preferred embodiment(s) is merely exemplary in nature and is in no way intended to limit the invention, its application, or uses.

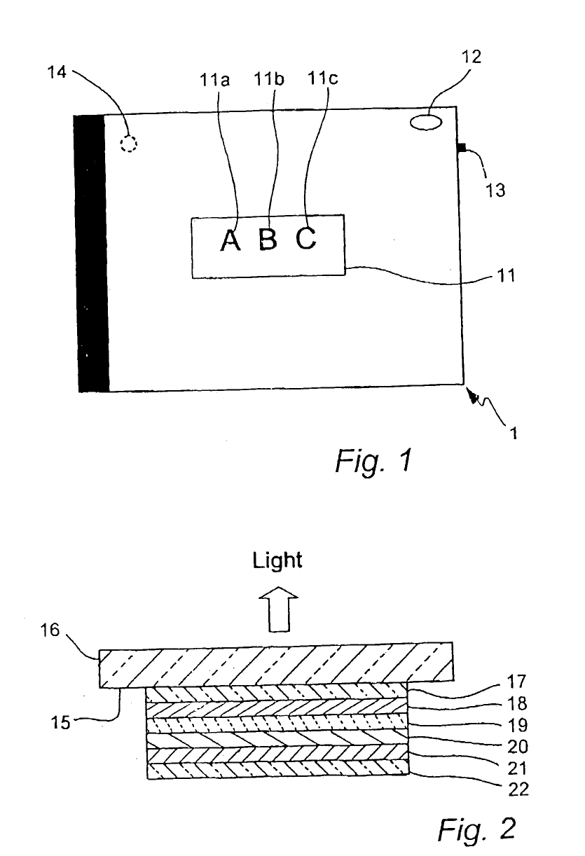

FIG. 1 shows a first CD box 1 according to the invention. The box comprises display area 11 consisting of OLEDs 11a-11c, photodetector 12, manually operable switch 13 and power source 14.

A cross-section of the box of FIG. 1 through OLED 11a is shown in FIG. 2. OLED 11a is located on the inner surface 15 of the transparent lid 16 of CD box 1 and comprises substrate 17 of glass and/or plastic, anode 18 of indium tin oxide, hole injecting layer 19 of PEDOT/PSS, electroluminescent material 20, cathode 21 and an encapsulating layer 22 of glass. Alternatively, the encapsulant may be a suitable barrier stack of alternating polymer/dielectric layers. OLED 11a is attached to inner surface 15 of CD box 1 by its substrate 17 by means of a suitable adhesive. It will be appreciated that attachment of the OLED 11a to inner surface 15 of CD box 1 protects the OLED from mechanical damage. It may also serve to inhibit atmospheric degradation of the OLED, and for this purpose encapsulating means (not shown) may be provided around the OLED to encapsulate the OLED in an airtight arrangement between the lid 16 and the encapsulating means. As described above, the encapsulant may be an airtight casing or a barrier film or barrier stack of alternating polymer/dielectric layers. Thus, the OLED may be encapsulated firstly by means of its substrate and a first barrier film/stack or airtight casing sealed to the substrate (primary encapsulation) and further encapsulated between a surface of the container for storage and a second barrier film/stack or airtight casing (secondary encapsulation).

The cathode of OLED 11a consists of a calcium/aluminum bilayer that is formed into the shape of a letter. The layer of aluminum provides a reflective surface. When OLED 11a is switched on, light is emitted in the shape of the cathode. When OLED 11a is switched off, the cathode shape is still visible by virtue of the reflective nature of the cathode.

Alternatives to the above arrangement will be apparent. In particular, the cathodes may be shaped into the form of words numerals, logos or artistic representations. Alternatively, the cathode could comprise an unshaped sheet of material wherein emission of light only occurs through gaps in an opaque template wherein said gaps spell out a word or provide the outline of a letter, logo, etc.

The embodiment of FIG. 1 comprises three independently addressable OLEDs 11a-c wherein each cathode is in the form of a letter. Each OLED is independently operable such that one or two of the OLEDs is on whilst the other one or two OLEDs are off. In particular, one or two of the OLEDs may be activated intermittently as part of an on/off cycle whilst the other one or two OLEDs remain continuously on. This pattern of light emission may be accomplished by means of drive circuitry that will be apparent to a skilled person.

Alternative OLED/container arrangements are envisaged, including but not limited to the following:

attachment of the OLED to an outer surface of the container by means of the encapsulant.

OLEDs wherein light is emitted from the encapsulant side of the device in which case the OLED is attached to the container by its encapsulant if on an inner surface of the container or attached to the container by its substrate if on an outer surface of the container such that light is emitted in an outward direction.

attachment of the OLED in an aperture provided within a wall of the container for storage. The aperture may be, for example, a hole cut into a side of the container and shaped to accept an OLED of a size and shape matching the hole. Separate means to retain the OLED within the aperture may be provided.

A system wherein the OLED is provided in the form of an insert, such as a rectangular card, that is inserted into means for retaining the insert located on a surface of the container such as one or more clips or a slot. The insert may also carry the power supply and drive circuitry for the OLED to give a self-contained display unit. Upon insertion, the insert may complete a circuit with circuitry provided on or in the container for storage. The information displayed on a container according to this system may be changed by changing the OLED insert.

The containers described above require separate manufacture of the OLED and the surface of the container to which the OLED is attached. In an alternative arrangement, the surface of the box may also serve as the substrate (in which case the OLED is manufactured on the surface of the box) or encapsulant for the OLED. In either case, either the cathode or anode of the OLED is in direct contact with said surface of the box.

The OLED of FIG. 1 is operable in response to a signal from photodetector 12 such that the display is engaged when the brightness of light incident on the photodetector exceeds a selected threshold value. Alternatively, the OLED of FIG. 1 may be engaged when brightness of light incident on the photodetector falls below a selected threshold value. In an further alternative arrangement, the brightness of the display is dependent on the brightness of ambient light as detected by the photodetector. Thus, the OLED is particularly bright in bright ambient light in order to increase visibility and decreases in brightness as the brightness of ambient light decreases to the point where it is off when no ambient light is incident on the photodetector. This arrangement is particularly advantageous for improving the contrast in the display of FIG. 1 wherein the cathode reflects ambient light. This OLED/photodetector arrangement is disclosed in WO 99/40559.

In an alternative embodiment, photodetector 12 may be replaced by or supplemented with a means for operating the organic light emitting device that is responsive to sound rather than light. This may take the form of a piezoelectric sensor that engages the OLED in response to the volume and/or frequency of sound detected by the sensor.

The OLED of FIG. 1 has as its power supply a 5V chemical cell and may also be provided with a voltage converter to step up or step down the voltage to a required level. An alternative, or supplementary power source may be provided. In particular, if the display is only to be activated upon exposure to light then the power source may be replaced by, or supplemented by, a photovoltaic cell. Further alternative power sources include the following:

A replaceable insert that is retained by means for retaining the power source located on or in the container for storage. This insert could carry both the OLED and the power source.

A rechargeable battery that may be rechargeable upon removal from the container for storage. Alternatively, the container for storage may comprise means for recharging of such a battery in situ such as a USB connection, or an inductive system wherein means are provided for creating an electromagnetic connection between the recharging means (inductor) and the container for storage. Where the container for storage is for an electronic storage medium, the recharging means may be integrated into the means for reading the medium, such as a games console or DVD/CD player.

Other power sources and recharging means will be apparent to a skilled person.

Switch 13 may be used to override the photodetector such that the display may be turned on or off at a fixed brightness at will. Switch 13 has three positions: on, off, and photodetector mode.

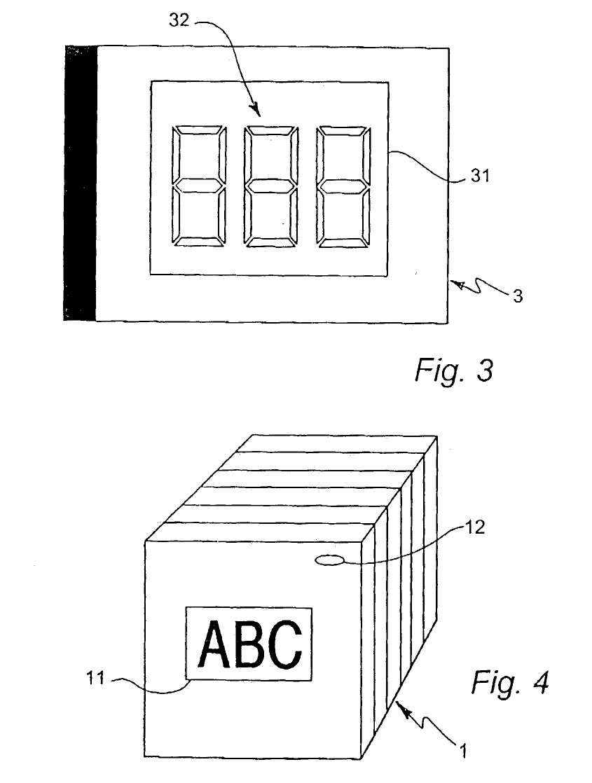

The information displayed by the aforementioned containers is dependant on the fixed shape of the cathode. Simple moving images, in particular numerals or letters, may also be produced by arranging a plurality of independently addressable OLEDs in the form of a segmented display as shown in FIG. 3. Here, CD box 3 comprises a display area 31 consisting of a plurality of OLEDs 32 which may be actuated independently of one another to generate an alphanumeric display by means of simple drive circuitry that will be apparent to a skilled person.

The photodetector/OLED arrangement can be used to maximize the useful lifetime of both the OLED and the power supply. In particular, when containers 1 of the invention are arranged in a stack as shown in FIG. 4 (such as in a shop) only the display area 11 of the container uppermost will be activated as the photodetector 12 of this container will be the only one in the stack that is exposed to light. Furthermore, the OLED of this uppermost container will switch itself off when in darkness (e.g. when the shop is shut).

The container for storage used in such a stack may have any of the features of the set forth above, e.g. power source, integration of OLED and container, etc.

Although the present invention has been described in terms of specific exemplary embodiments, it will be appreciated that various modifications, alterations and/or combinations of features disclosed herein will be apparent to those skilled in the art without departing from the spirit and scope of the invention as set forth in the following claims.

What is claimed is:

1. A container for storage wherein an organic light emitting device is provided on a surface thereof or as part of a wall thereof such that light emitted from the organic light emitting device is visible from the exterior of the container.

2. A container for storage according to claim 1 wherein the container for storage is provided with a plurality of independently operable organic light emitting devices.

3. A container for storage according to claim 1 or 2 wherein at least one of the organic light emitting device is a polymeric light emitting device.

4. A container for storage according to claim 1, 2 or 3 wherein the organic light emitting device comprises a semi-transparent electrode for transmission of light emitted from an electroluminescent material and a reflective material for reflection of ambient light provided on the side of the electroluminescent material distant from said semi-transparent electrode.

5. A container for storage as defined in claim 4 wherein the semi-transparent electrode is an anode and the reflective material comprises a cathode layer.

6. A container for storage according to any preceding claim further comprising at least one means for operating the organic light emitting device.

7. A container for storage according to claim 6 wherein the means for operating comprises a photodetector that activates the organic light emitting device upon exposure to ambient light.

8. A container for storage according to claim 7 wherein the means for operating further comprises a manually operable switch that is capable of overriding the operation of the photodetector.

9. A container for storage according to any preceding claim wherein the organic light emitting device is removably attached to a surface of the container for storage.

10. A container for storage according to claim 9 wherein the container for storage is provided with means for retaining the organic light emitting device.

11. A container for storage according to any preceding claim wherein the organic light emitting device comprises a substrate in contact with one electrode and an encapsulant in contact with the other electrode wherein the substrate or encapsulant is provided by a wall of the electroluminescent device.

12. A container for storage according to any preceding claim wherein the container is a container for storage of audio and/or video storage media.

13. A container for storage according to any preceding claim that further comprises a power source that provides a voltage of less than 20V for operation of the organic light emitting device.

14. A container for storage as defined in claim 13 wherein the power source provides a voltage in the range of 2-5V.

15. A container for storage according to any preceding claim wherein the organic light emitting device is provided on an inner surface of a transparent wall of the container for storage.

16. A kit comprising a container for storage and at least one organic electroluminescent device attachable to at least one surface of said container for storage such that light emitted from the organic light emitting device is visible from the exterior of the container when the kit is assembled.

17. A kit according to claim 16 wherein the organic electroluminescent device is removably attachable to the at least one surface of said container for storage.

18. A method of forming a container for storage as defined in claim 1 comprising the step of attaching at least one organic light emitting device to at least one surface of a container for storage.

19. A method of forming a container for storage according to claim 18 wherein the organic light emitting device is attached to the container for storage by lamination.

20. A method of forming a container for storage according to claim 18 wherein the organic light emitting device is attached to the container for storage by means of an adhesive.

21. A plurality of units, each unit having:
a first side and an opposing second side,
a light source on said first side such that light emitted from the light source is visible from the exterior of the unit, and
a detection means on said first side
wherein said plurality of units is arranged in a stack such that the first side of at least one of the endmost units of the stack faces outward, and wherein the light source provided on said at least one endmost unit is activatable in response to a signal from the detection means provided on said at least one endmost unit, all other light sources within the stack being deactivated.

22. A plurality of units according to claim 21 wherein the detection means comprises a means for detecting light

23. A plurality of units according to claim 19 wherein the first or second surface of the second unit is in contact with the first surface of the first unit and overlays at least part of the means for detecting light.

24. A plurality of units according to claim 22 wherein the first surface or second surface of the second unit overlays the entire area of the means for detecting light.

25. A plurality of units according to claims 21-24 wherein the light source is an organic light emitting device.

26. A plurality of units according to claims 21-25 wherein the light source is activated upon detection of ambient light by the means for detecting light.
